(19) United States
(12) Patent Application Publication
(10) Pub. No.: US 2025/0151126 A1
(43) Pub. Date: May 8, 2025

(54) SYSTEMS AND METHODS FOR TIMING ENHANCEMENT IN STORE AND FORWARD MODE

(71) Applicant: ZTE CORPORATION, Shenzhen (CN)

(72) Inventors: Yachao YIN, Shenzhen (CN); Nan ZHANG, Shenzhen (CN); Fangyu CUI, Shenzhen (CN); Wei CAO, Shenzhen (CN)

(73) Assignee: ZTE CORPORATION, Shenzhen (CN)

(21) Appl. No.: 19/018,725

(22) Filed: Jan. 13, 2025

Related U.S. Application Data
(63) Continuation of application No. PCT/CN2023/093604, filed on May 11, 2023.

(51) Int. Cl. H04W 74/0833; H04B 7/185; H04L 12/54

(52) U.S. Cl. CPC H04W 74/0833; H04B 7/1851; H04L 12/54

(57) ABSTRACT

Presented are systems and methods for timing enhancement in store and forward mode. A wireless communication node may configure a waiting duration indicative of a duration to a next service period of a satellite, and a serving duration indicative of a duration of a service period of the satellite. The wireless communication node may send the waiting duration and the serving duration, to be used by a wireless communication device during a random access procedure.

### CROSS-REFERENCE TO RELATED APPLICATION

This application claims the benefit of priority under 35 U.S.C. § 120 as a continuation of PCT Patent Application No. PCT/CN2023/0093604, filed on May 11, 2023, the disclosure of which is incorporated herein by reference in its entirety.

### TECHNICAL FIELD

The disclosure relates generally to wireless communications, including but not limited to systems and methods for timing enhancement in store and forward mode.

### BACKGROUND

Coverage is a fundamental aspect of cellular network deployments. Mobile operators rely on different types of network nodes to offer blanket coverage in their deployments. As a result, new types of network nodes have been considered to increase the flexibility of mobile operators for their network deployments. For example, certain systems or architecture introduce integrated access and backhaul (IAB), which may be enhanced in certain other systems, as a new type of network node not requiring a wired backhaul. Another type of network node is the RF repeater which simply amplify-and-forward any signal that they receive. RF repeaters have seen a wide range of deployments in 2G, 3G and 4G to supplement the coverage provided by regular full-stack cells.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A wireless communication node (e.g., a base station (BS),which can be part of a regenerative satellite, or separate from a satellite for instance) may configure a waiting duration indicative of a duration (e.g., T_{wait}) to a next service period of a satellite, and a serving duration indicative of a duration (e.g., Tₛₑᵣᵥₑ) of a service period of the satellite. The wireless communication node may send the (indication of the) waiting duration and the serving duration, to be used by a wireless communication device (e.g., a user equipment (UE)) during a random access procedure. In some embodiments, the wireless communication node (e.g., a regenerative satellite) may send the waiting duration and the serving duration to a UE directly. In certain embodiments, the wireless communication node (e.g., a BS) may send the waiting duration and the serving duration to a UE via a satellite (e.g., a transparent satellite). The random access procedure may comprise a 4-step random access procedure, or a 2-step or contention-free random access procedure.

In some embodiments, the waiting duration may include at least one of: a duration of one orbital cycle of the satellite, a processing duration at the wireless communication node, a round trip propagation time between the satellite and the wireless communication node, a round trip propagation time between the satellite and the wireless communication device, a fixed value, or a sum of a fixed value and an offset value.

In some embodiments, the wireless communication node may send the waiting duration and the serving duration to the satellite via at least one of: a master information block (MIB) signaling, a system information block (SIB) signaling, or a radio resource control (RRC) signaling. The satellite may store the waiting duration and the serving duration. The satellite may send the waiting duration and the serving duration to the wireless communication device.

In some embodiments, the wireless communication device may send, during a first instance of the serving duration, a Msg1 or MsgA to the satellite at a start time of a first instance of the waiting period (e.g., t1 in FIG. 9). The satellite may send a Msg2 or MsgB to the wireless communication device responsive to expiration of the first instance of the waiting period (e.g., t4 in FIG. 9). The wireless communication device may receive the Msg2 or MsgB from the satellite in a random access response (RAR) window with a delay comprising a sum of a first timing advance (TA1) and a second timing advance (TA2). The wireless communication device may send, during a second instance of the serving duration, a Msg3 with a timing advance comprising the sum of the TA1 and the TA2, at a start time of a second instance of the waiting period (e.g., t5 in FIG. 9). The wireless communication device may monitor to receive a Msg4 in a contention resolution window after a delay comprising a sum of a third timing advance (TA3) and a fourth timing advance (TA4), after expiration of the second instance of the waiting period.

In some embodiments, the wireless communication device may determine to send the Msg1, the Msg3 or the MsgA if (e.g., on condition that) at least one of: a calculated elevation angle is greater than a threshold of elevation angle, a measured reference signal received power (RSRP) is higher than a RSRP threshold, a calculated distance is less than a distance threshold between the wireless communication device and the satellite, or a residual portion of the serving duration calculated by wireless communication device is larger than a sum of a scheduled duration (e.g., K, the scheduled duration for DCI scheduled Msg3) and a round trip propagation time between the satellite and the wireless communication device.

In some embodiments, the TA1 can be a propagation delay calculated by the wireless communication device at the start time of the first instance of the waiting period (e.g., t1 in FIG. 9). The TA2 can be a propagation delay between the wireless communication device and the satellite calculated when the satellite sends the Msg2 or MsgB (e.g., t4 in FIG. 9) to the wireless communication device. The TA3 can be a propagation delay between the wireless communication device and the satellite calculated when the wireless communication device sends the Msg3 (e.g., t5 in FIG. 9). The TA4 can be a propagation delay between the wireless communication device and the satellite calculated when the wireless communication device receives the Msg4 (e.g., t8 in FIG. 9).

In some embodiments, if the Msg2, Msg4 or MsgB is not (e.g., not successfully) received by the wireless communication device responsive to expiration of the waiting period: the wireless communication device may re-send the Msg1, Msg3 or MsgA to the satellite at a start time of another instance of the waiting period, after a defined offset time (ΔT, mapped to higher uplink (UL) coverage for instance).

In some embodiments, the wireless communication node on the satellite may send the waiting duration and the serving duration to the wireless communication device. The wireless communication device may send, during a first instance of the serving duration, a Msg1 or MsgA to the satellite at a start time of a first instance of the waiting period (e.g., t1 in FIG. 13). The satellite may send a Msg2 or MsgB to the wireless communication device (e.g., t2 in FIG. 13). Responsive to expiration of the first instance of the waiting period, the wireless communication device may receive a Msg2 from the satellite in a random access response (RAR) window with a delay comprising two times of a timing advance (TA). The wireless communication device may send, during a second instance of the serving duration, a Msg3 at a start time of a second instance of the waiting period (e.g., t3 in FIG. 13). The wireless communication device may monitor to receive a Msg4 in a contention resolution window after a delay comprising two times of the TA, after expiration of the second instance of the waiting period. The TA can be a propagation delay between the wireless communication device and the satellite. If the Msg2, Msg4 or MsgB is not received by the wireless communication device responsive to expiration of the first instance or second instance of the waiting period: the wireless communication device can re-send the Msg1, Msg3 or MsgA to the satellite at a start time of another instance of the waiting period, after a defined offset time (ΔT, mapped to higher uplink (UL) coverage for example).

In some embodiments, the wireless communication node (e.g., gNB-CU) may send (an indication of) the waiting duration and the serving duration to the satellite. The satellite may store the waiting duration and the serving duration. The satellite may send the waiting duration and the serving duration to the wireless communication device. The wireless communication device may send, during a first instance of the serving duration, a Msg1 or MsgA to the satellite at a start time of a first instance of the waiting period (e.g., t1 in FIG. 17). The satellite may send a Msg2 or MsgB to the wireless communication device responsive to expiration of the first instance of the waiting period (e.g., t3 in FIG. 17). The wireless communication device may receive the Msg2 or MsgB and first radio resource control (RRC) information from the satellite, in/during a random access response (RAR) window with/after a delay comprising a sum of a first timing advance (TA1) and a second timing advance (TA2). The wireless communication device may send, during a second instance of the serving duration, a Msg3 with/after a timing advance comprising the sum of the TA1 and the TA2, at a start time of a second instance of the waiting period (e.g., t4 in FIG. 17). The wireless communication device may monitor to receive a Msg4 and second RRC information, in/during a contention resolution window after a delay comprising a sum of a third timing advance (TA3) and a fourth timing advance (TA4), after expiration of the second instance of the waiting period.

In some embodiments, the TA1 can be a propagation delay calculated by the wireless communication device at the start time of the first instance of the waiting period (e.g., t1 in FIG. 17). The TA2 can be a propagation delay between the wireless communication device and the satellite, that is calculated/determined (e.g., using a GNSS module of the wireless communication device) when the satellite sends the Msg2 or MsgB to the wireless communication device (e.g., t3 in FIG. 17). The TA3 can be a propagation delay between the wireless communication device and the satellite calculated/determined (e.g., using a GNSS module of the wireless communication device) when the wireless communication device sends the Msg3 (e.g., t4 in FIG. 17). The TA4 can be a propagation delay between the wireless communication device and the satellite calculated when the wireless communication device receives the Msg4. If the Msg2, Msg4 or MsgB is not received by the wireless communication device responsive to expiration of the waiting period: the wireless communication device may re-send the Msg1, Msg3 or MsgA (e.g., attempt to send another Msg1, Msg3 or MsgB) to the satellite at a start time of another instance of the waiting period, after a defined offset time (ΔT, mapped to higher uplink (UL) coverage). The wireless communication device may receive the Msg2 or MsgB from the satellite in a RAR window that is extended to incorporate a common timing advance (e.g., configured/determined by the wireless communication node) for a plurality of wireless communication devices, or a maximum round-trip propagation delay between the wireless communication device and the satellite. The wireless communication device may monitor to receive the Msg4 in a contention resolution window that is extended/modified to incorporate the common timing advance, or the maximum round-trip propagation delay between the wireless communication device and the satellite.

In some embodiments, a wireless communication device (e.g., a UE) may receive a configuration comprising a waiting duration indicative (e.g., T_{wait}) of a duration to a next service period of a satellite, and a serving duration indicative (e.g., Tₛₑᵣᵥₑ) of a duration of a service period of the satellite, to be used during a random access procedure. The waiting duration and the serving duration can be configured by a wireless communication node (e.g., a BS, which can be part of a regenerative satellite for instance).

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with some embodiments of the present disclosure;

FIG. 2 illustrates a block diagram of an example base station and a user equipment device, in accordance with some embodiments of the present disclosure;

FIG. 3 illustrates a schematic diagram of operation in a store and forward mode in non-terrestrial network (NTN), in accordance with some embodiments of the present disclosure;

FIG. 4 illustrates a schematic diagram of modified operation in a store and forward mode between satellites, in accordance with some embodiments of the present disclosure;

FIG. 5 illustrates a schematic diagram of a transparent satellite in non-terrestrial network (NTN), in accordance with some embodiments of the present disclosure;

FIG. 6 illustrates a schematic diagram of a regenerative satellite in non-terrestrial network (NTN), in accordance with some embodiments of the present disclosure;

FIG. 7 illustrates a schematic diagram of a regenerative satellite with a separate gNB-CU in non-terrestrial network (NTN), in accordance with some embodiments of the present disclosure;

FIG. 8 illustrates a flow diagram of an example application of T_{wait} and Tₛₑᵣᵥₑ for timing of random access channel (RACH), in accordance with some embodiments of the present disclosure;

FIG. 9 illustrates a sequence diagram for timing enhancement on 4-step RACH for a transparent satellite, in accordance with some embodiments of the present disclosure;

FIG. 10 illustrates a sequence diagram for timing enhancement on failure of 4-step RACH for a transparent satellite, in accordance with some embodiments of the present disclosure;

FIG. 11 illustrates a sequence diagram for timing enhancement on 2-step RACH/contention free (CF) RACH for a transparent satellite, in accordance with some embodiments of the present disclosure;

FIG. 12 illustrates a sequence diagram for timing enhancement on failure of 2-step RACH/CF RACH for a transparent satellite, in accordance with some embodiments of the present disclosure;

FIG. 13 illustrates a sequence diagram for timing enhancement on 4-step RACH for a regenerative satellite, in accordance with some embodiments of the present disclosure;

FIG. 14 illustrates a sequence diagram for timing enhancement on failure of 4-step RACH for regenerative satellite, in accordance with some embodiments of the present disclosure;

FIG. 15 illustrates a sequence diagram for timing enhancement on 2-step RACH/CF RACH for a regenerative satellite, in accordance with some embodiments of the present disclosure;

FIG. 16 illustrates a sequence diagram for timing enhancement on failure of 2-step RACH/CF RACH for a regenerative satellite, in accordance with some embodiments of the present disclosure;

FIG. 17 illustrates a sequence diagram for timing enhancement on 4-step RACH for a regenerative satellite, with a gNB DU/CU split, in accordance with some embodiments of the present disclosure;

FIG. 18 illustrates a sequence diagram for timing enhancement on 2-step RACH/CF RACH for a regenerative satellite, with a gNB DU/CU split, in accordance with some embodiments of the present disclosure; and

FIG. 19 illustrates a flow diagram of an example method for timing enhancement in store and forward mode/operation, in accordance with some embodiments of the present disclosure.

### DETAILED DESCRIPTION

### 1. Mobile Communication Technology and Environment

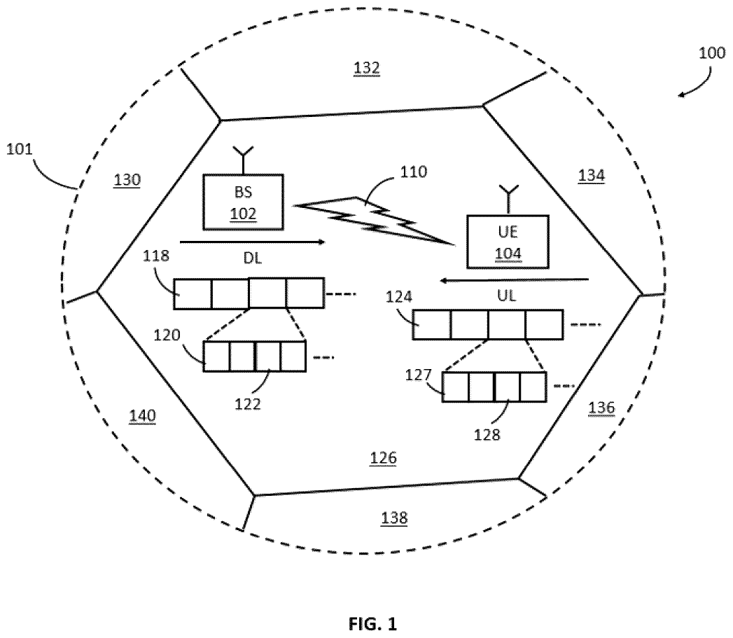

FIG. 1 illustrates an example wireless communication network, and/or system, 100 in which techniques disclosed herein may be implemented, in accordance with some embodiments of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

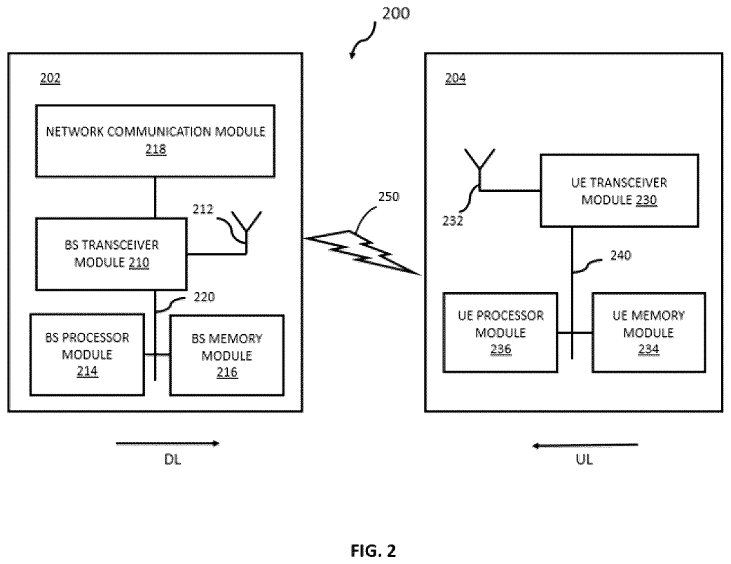

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Timing Enhancement in Store and Forward Mode

In non-terrestrial networks (NTN), a large delay can be generated due to long propagation distances involved in information exchange between a user equipment (UE) and a base station (BS). Furthermore, in store and forward mode, a larger delay may occur when a satellite moves (e.g., along an orbital path) to a UE again for signaling or information exchange. To address the challenges posed by large delays and to achieve uplink synchronization, it may be beneficial to implement timing enhancements (e.g., adjustments) on a random access procedure. Moreover, it is important to note that the timing enhancements in the random access channel (RACH) procedure may vary due to the specific satellite architecture/type, such as transparent and regenerative architectures, as well as the types of RACH employed in the system. Therefore, the present disclosure describes various timing enhancements of RACH procedure for transparent and regenerative satellites with store and forward mode in NTN.

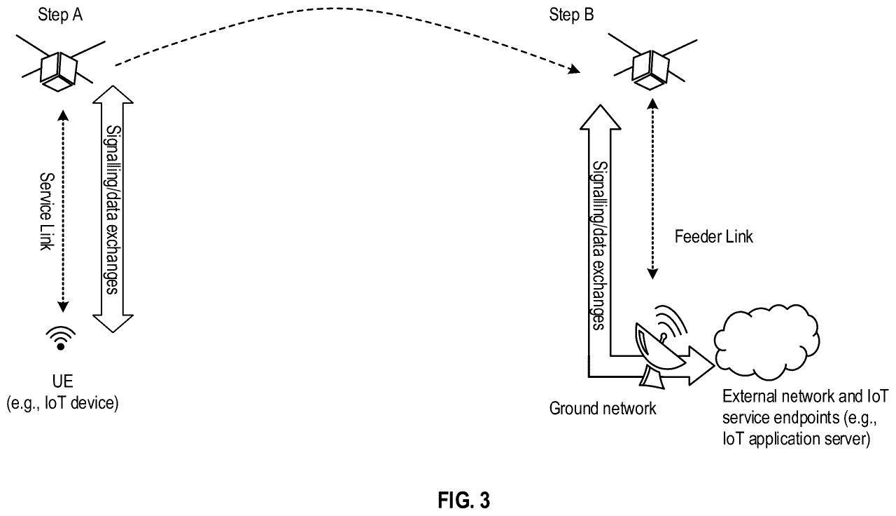

FIG. 3 illustrates a schematic diagram of operation in a store and forward mode in non-terrestrial network (NTN), in accordance with some embodiments of the present disclosure. A structure of store and forward mode in NTN is illustrated in FIG. 3. A link between a UE and a satellite can be a service link. A link between a gateway and a satellite can be a feeder link and can be common for all UEs. During step A, there can only be a connected service link between the UE and the satellite (e.g., the satellite can only work/communicate on the service link without feeder link connection/communications). During step B, there can only be a connected feeder link between the gateway and the satellite (e.g., the satellite can only work/communicate on the feeder link without a service link connection/communications at the same time). When the satellite moves between Step A and Step B, a signaling/data exchange can be performed by using the satellite's ability to perform store and forward.

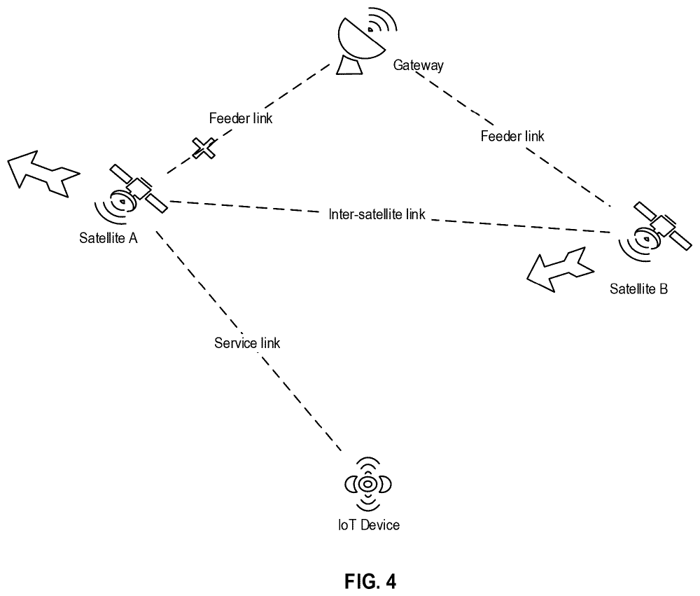

FIG. 4 illustrates a schematic diagram of modified operation in store and forward mode between satellites, in accordance with some embodiments of the present disclosure. As shown in FIG. 4, the modified operation in store and forward between satellites can be a particular approach that can achieve a connection between a UE and a gateway via an inter-satellite link. For example, an inter-satellite link between satellite A and satellite B can be established to keep a communication connection between the UE and the gateway when a feeder link between satellite A and gateway is disabled or non-operational.

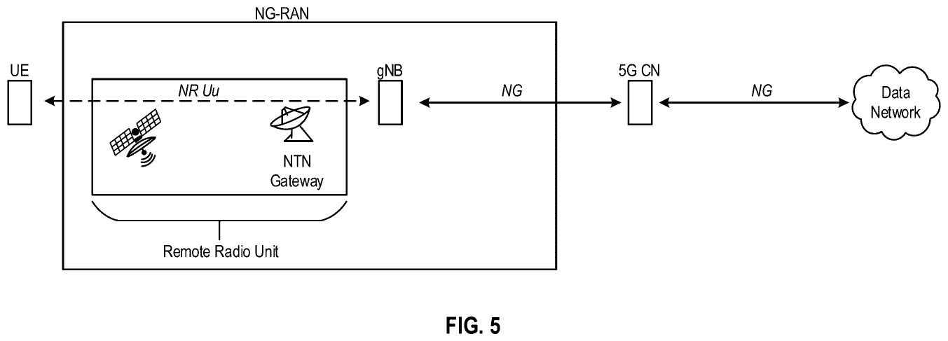

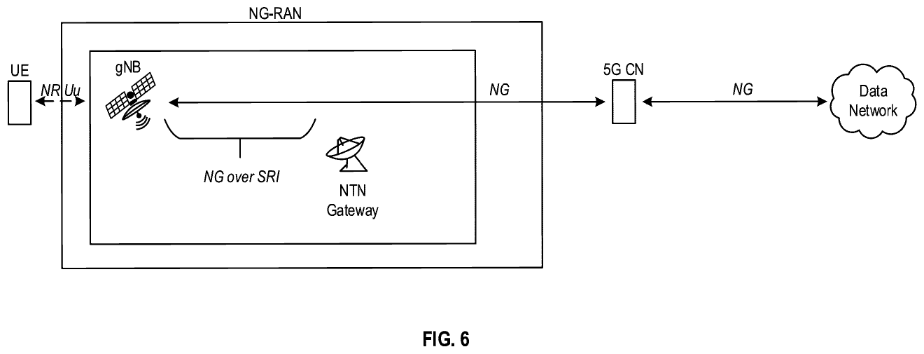

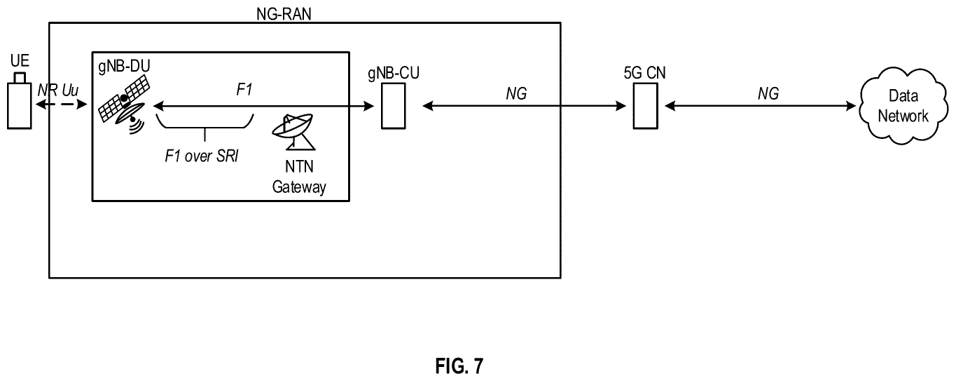

FIG. 5 illustrates a schematic diagram of a transparent satellite in non-terrestrial network (NTN), in accordance with some embodiments of the present disclosure. FIG. 6 illustrates a schematic diagram of a regenerative satellite in non-terrestrial network (NTN), in accordance with some embodiments of the present disclosure. A satellite payload can be divided into a transparent payload and a regenerative payload as shown in FIGS. 5 and 6. For a transparent satellite, the satellite can be considered as an analog radio frequency (RF) repeater, which can realize/perform frequency conversion and RF amplifier in uplink and downlink directions. For a regenerative satellite, base station functions can be on the satellite, which can realize/perform/include radio frequency filtering, frequency conversion and amplification as well as demodulation/decoding, switching and/or routing, and/or coding/modulation. In particular, for gNB DU/CU split in a regenerative satellite, functions of some higher layer (e.g., radio resource control (RRC)) can be split out into a gNB-CU (e.g., separate from the satellite). FIG. 7 illustrates a schematic diagram of a regenerative satellite based on such a gNB-CU in non-terrestrial network (NTN), in accordance with some embodiments of the present disclosure.

Based on above introduction, timing enhancements on a RACH procedure can be performed for different scenarios with consideration of transparent and regenerative satellite modes for (e.g., to support/facilitate) store and forward operations in NTN.

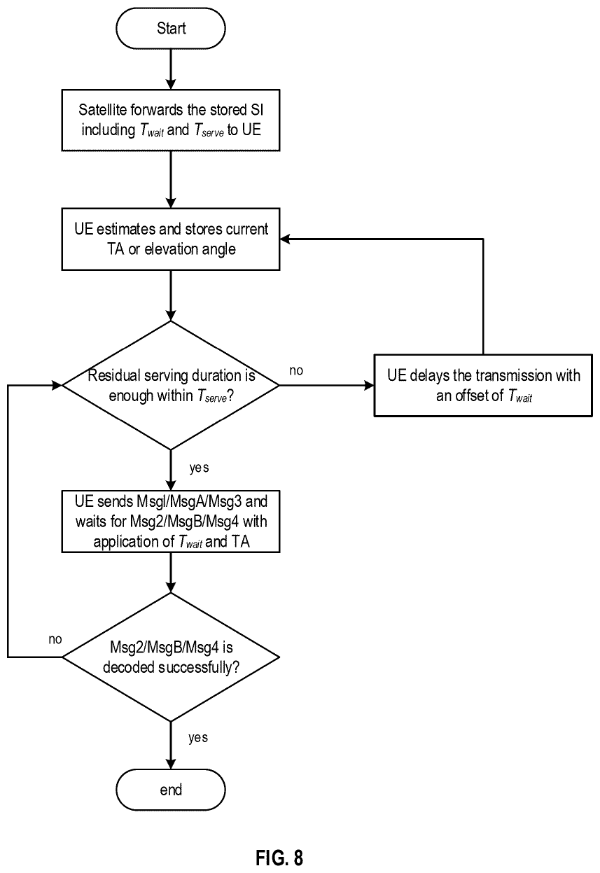

FIG. 8 illustrates a flow diagram of an example application of T_{wait} and Tₛₑᵣᵥₑ for timing of random access channel (RACH), in accordance with some embodiments of the present disclosure. For a configuration of T_{wait}, a waiting duration may include at least one of: (a) a periodic duration of a satellite orbit, (b) a processing duration at a gateway, (c) a round trip propagation delay between a satellite and a gateway, (d) a round trip propagation delay between a satellite and a UE, or (e) a timing offset.

For the configuration of Tₛₑᵣᵥₑ, a serving duration can be the maximum duration that a UE is covered by (e.g., received cellular coverage from) a satellite. To determine whether a residual portion of (or within) a serving duration is enough/available, the determination methods can be summarized as determining/detectingthe following: (1) a current elevation angle is less than a threshold of an elevation angle; (2) a reference signal received power (RSRP) at current time is higher than the RSRP threshold; (3) a distance at the current time is less than a threshold of a distance between a UE and a satellite; or (4) a residual (portion of the) serving duration is larger than a sum of a scheduled duration (e.g., K) and a round trip propogation time (RTT), where the residual serving duration can be calculated by a current coordinated universal time (UTC), the UTC time when the timer of Tₛₑᵣᵥₑ starts, and Tₛₑᵣᵥₑ (e.g., Tₛₑᵣᵥₑ-(T_{current,UTC}-T_{startofTimer,UTC}), or the difference between serving duration and current serving duration (e.g., Tₛₑᵣᵥₑ-T_{current, serve}). K is the scheduled duration for DCI scheduled Msg3. RTT is the maximum round trip time between the UE and the satellite.

For a UE with a global navigation satellite system (GNSS) module, a timing advance (TA) can be calculated by a location of a UE and a satellite ephemeris to delay/shift a random access response (RAR) window.

For a UE without a GNSS module, extending a range of RAR window with a maximum RTT between the UE and the satellite may cover an exact round trip delay.

### Implementation Example 1: Timing Enhancement of RACH is Based on Waiting Duration and Serving Duration for Transparent Satellite Mode

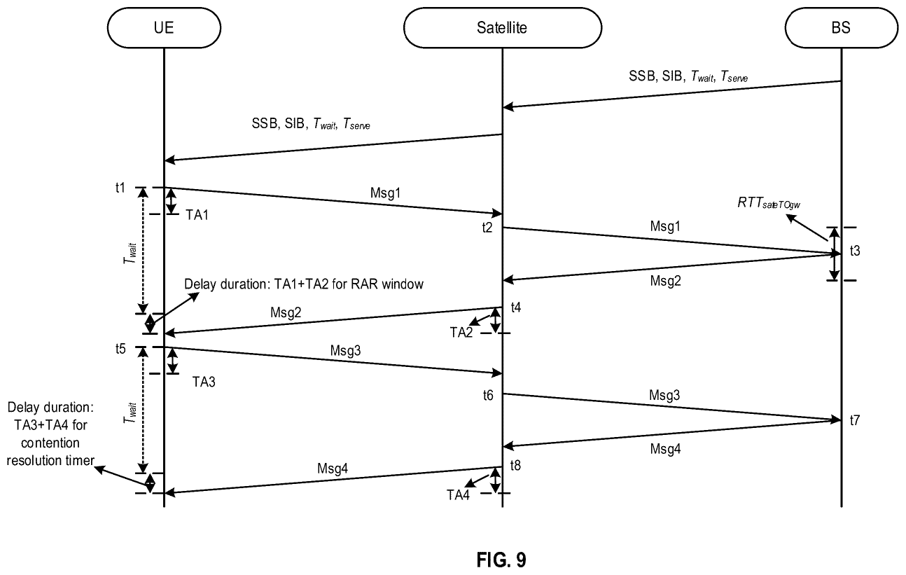

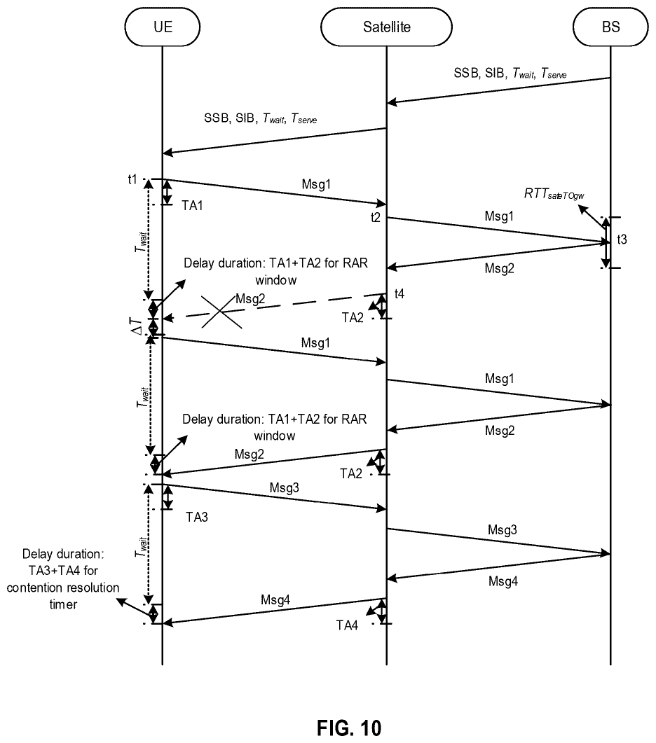

Case 1-1: for a transparent satellite in store and forward mode (e.g., the satellite stores a synchronization signal block (SSB), a system information block (SIB), T_{wait}, Tₛₑᵣᵥₑ received from a BS, then forwards to a UE later), a timing enhancement on 4-step random access can be specified. FIG. 9 illustrates a sequence diagram for timing enhancement (e.g., adjustment) on 4-step RACH for a transparent satellite, in accordance with some embodiments of the present disclosure. FIG. 10 illustrates a sequence diagram for timing enhancement on failure of 4-step RACH for a transparent satellite, in accordance with some embodiments of the present disclosure.

Before a random access procedure, a satellite may send a stored synchronization signal block (SSB), system information (SI), a waiting duration T_{wait} and a serving duration Tₛₑᵣᵥₑ to a UE. The waiting duration can be indicated with following options:

Option-1: As a constant value of waiting duration T_{wait}, T_{wait}>T_{period}, which ensures the successful transmission and/or processing of Msg1 according to a network configuration (e.g., a physical random access channel (PRACH) occasion, a preamble index at the minimum reference signal received power (RSRP) threshold, an elevation angle threshold, and/or a distance threshold). The waiting duration may include at least one of: a period duration of a satellite orbit, a processing duration at a gateway, a round propagation delay between a satellite and a gateway, or a round propagation delay between a satellite and a UE.

Option-2: As an offset and a constant value of waiting duration, where T_{wait}=ΔT+T_{wait,initial}. Each value of the offset can be mapped with a corresponding RSRP threshold, elevation angle threshold, and/or distance threshold. For example, the following Table 1 may be configured.

TABLE 1

| The offset of | RSRP | Elevation angle | Distance |
|---|---|---|---|
| waiting duration | threshold | threshold | threshold |
| ΔT₁ | X1 | Y1 | Z1 |
| ΔT₂ | X2 | Y2 | Z2 |
| ΔTₙ, ΔTₘ, ΔTⱼ | Xn | Ym | Zj |

At t1 time, a UE may send Msg1 to a satellite and may start a timer of a waiting duration T_{wait} to wait for Msg2. The UE may calculate and may store a first timing advance (TA1) (e.g., a propagation delay between the UE and the satellite).

At t2 time, the satellite may forward the stored Msg1 to a gateway when the satellite passes over the gateway (e.g., along the satellite's orbital path).

At t3 time, the gateway may send Msg2 to the satellite if Msg1 is decoded correctly at the gateway.

At t4 time, the satellite may forward the stored Msg2 to the UE when the timer of waiting duration T_{wait} has expired. The UE may receive Msg2 at/within a random access response (RAR) window adjusted with a delay of a sum of a first timing advance (TA1) and a second timing advance (TA2). The TA1 can be the calculated propagation delay stored by the UE at t1 time. The TA2 can a calculated propagation delay between the UE and the satellite at t4 time. Otherwise, as shown in FIG. 10, if Msg2 is not received by the UE, the UE may restart random access after an offset of ΔT which can be mapped to higher uplink (UL) coverage. The timer of waiting duration of T_{wait} may be also restarted. For example, the random access can be restarted with a delay of a larger time offset at a higher reference signal received power (RSRP), a higher elevation angle, or a lower distance according to the mapping table above.

At t5 time, the UE may send Msg3 with a timing advance of the sum of TA1+TA2. The TA2 can be the propagation delay between the UE and the satellite. The UE may wait for Msg4 within a contention resolution window (e.g., prior to expiration of a contention resolution timer) after a delay of a third timing advance and a fourth timing advance (e.g., TA3+TA4) when/after the timer of waiting duration T_{wait} has expired. The TA3 and the TA4 can be a propagation delay between the UE and the satellite, calculated when the UE sends Msg3 and receives Msg4, respectively.

At t6 time, the satellite may forward the stored Msg3 to the gateway, and a conflict detection and a permanent cell radio network temporary identifier (C-RNTI) allocation can be carried out.

At t7 time, the network may send Msg4 to the satellite when Msg3 is correctly decoded.

At t8 time, the satellite may forward the stored Msg4 to the UE when the satellite passes over the UE. If Msg4 is decoded successfully, the random access can be complete. Otherwise, the UE may restart the random access with higher UL coverage, after waiting a new offset of, ΔT within a serving duration of Tₛₑᵣᵥₑ.

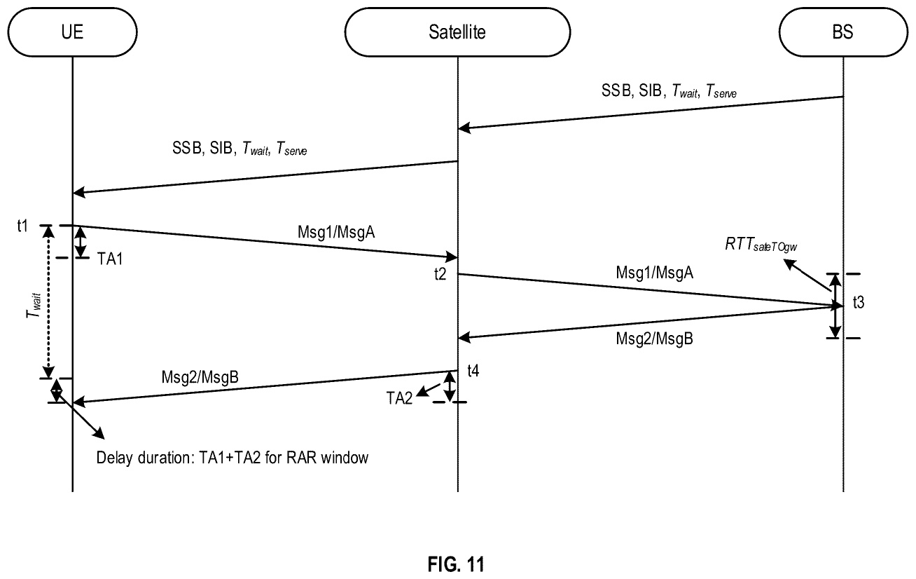

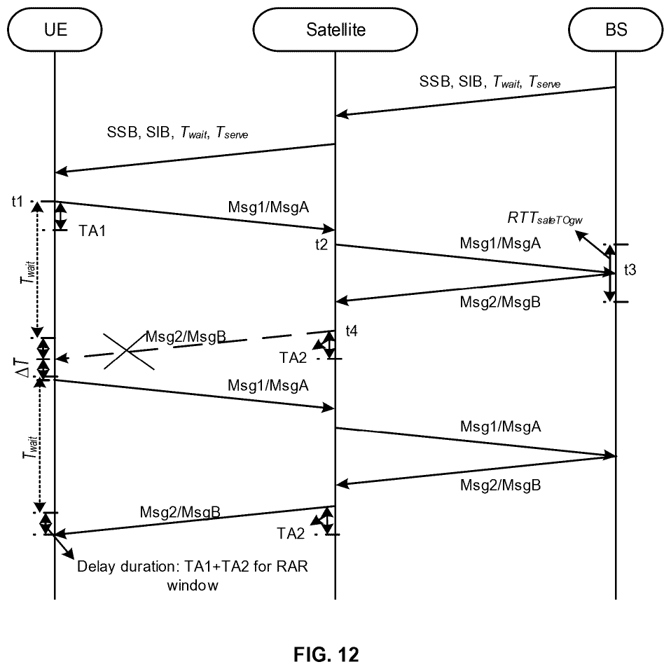

Case 1-2: For 2-step random access or contention-free random access in transparent satellite mode, application of a waiting duration T_{wait} and a serving duration Tₛₑᵣᵥₑ can be feasible/supported. FIG. 11 illustrates a sequence diagram for timing enhancement on 2-step RACH/control function (CF) RACH for a transparent satellite, in accordance with some embodiments of the present disclosure. FIG. 12 illustrates a sequence diagram for timing enhancement on failure of 2-step RACH/CF RACH for transparent satellite, in accordance with some embodiments of the present disclosure.

Before a starting/performing a random access procedure, a satellite sends a stored synchronization signal block (SSB), system information (SI), a waiting duration T_{wait} and/or a serving duration Tₛₑᵣᵥₑ to a UE. The waiting duration can be indicated with following options.

Option-1: As a constant value of waiting duration T_{wait} larger than a period duration of satellite orbit, T_{wait}>T_{period}, which at least ensures successful sending/processing of Msg1/MsgA with a network configuration at a minimum higher reference signal received power (RSRP) threshold, an elevation angle threshold, or a distance threshold.

Option-2: As an offset and a constant value of waiting duration, where T_{wait}=ΔT+T_{wait,initial}. Different values of the offset can be mapped with corresponding values of RSRP threshold, elevation angle threshold, and/or distance threshold. The time offset can be less than a serving duration (e.g., ΔT≤Tₛₑᵣᵥₑ). The T_{wait}, Tₛₑᵣᵥₑ, ΔT, and T_{wait,initial} can be indicated through a SIB signaling to UEs. For the mapping relationships, the following Table 2 may be configured.

TABLE 2

| The offset of waiting | RSRP | Elevation angle | Distance |
|---|---|---|---|
| duration | threshold | threshold | threshold |
| ΔT₁ | X1 | Y1 | Z1 |
| ΔT₂ | X2 | Y2 | Z2 |
| ΔTₙ, ΔTₘ, ΔTⱼ | Xn | Ym | Zj |

At t1 time, a UE may send Msg1/MsgA to a satellite and may start a timer of/for timing duration T_{wait} to wait for Msg2/MsgB. The UE may calculate and may store a first timing advance (TA1) (e.g., a propagation delay between the UE and the satellite).

At t2 time, the satellite may forward the stored Msg1/MsgA to a gateway when the satellite passes over the gateway.

At t3 time, the gateway may send Msg2/MsgB to the satellite if Msg1/MsgA is decoded correctly.

At t4 time, the satellite may forward the stored Msg2/MsgB to the UE when the timer of waiting duration T_{wait} is expired. The UE may receive Msg2 at a random access response (RAR) window with (or shifted/adjusted by) a delay of a sum of a first timing advance (TA1) and a second timing advance (TA2). The TA2 can be a calculated propagation delay between the UE and the satellite at t4 time. Otherwise, as shown in FIG. 12, if Msg2/MsgB is not received by the UE, the UE may restart the random access by an offset of ΔTmapped to higher UL coverage. The timer of waiting duration of T_{wait} can be also restarted. For example, the random access can be restarted with a delay of a larger time offset at a higher RSRP, a higher elevation angle, or a lower distance according to the mapping table above.

For the successful decoding of preamble but failure of Msg3 for MsgA, the waiting duration can be used for fallback procedures of 4-step RACH.

### Implementation Example 2: Timing Enhancement of RACH is Based on Waiting Duration and Serving Duration for Regenerative Satellite With an on-Board gNB

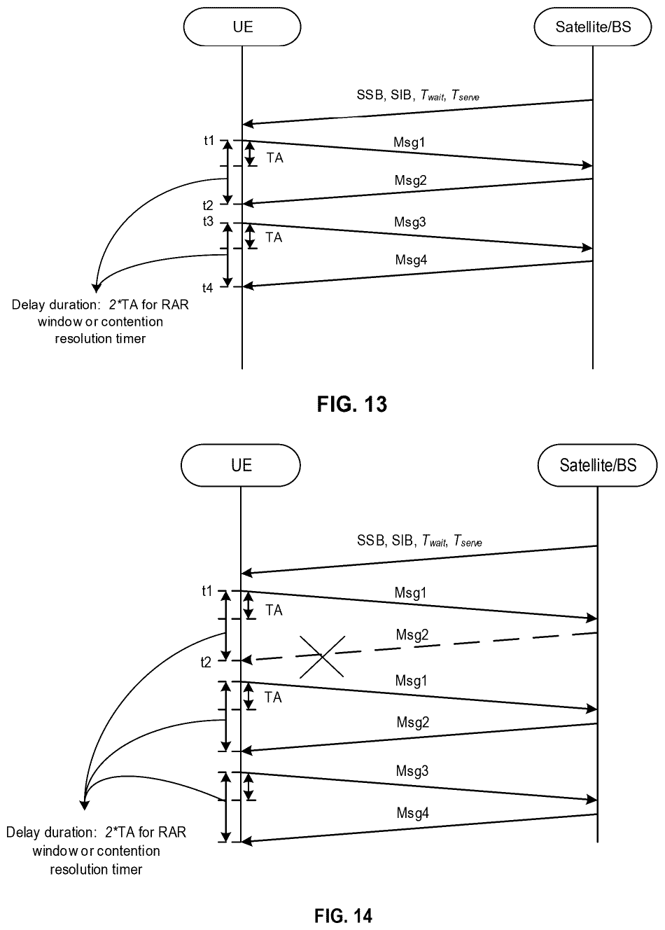

Case 2-1: For regenerative satellite with an on-board gNB, a timing enhancement on 4-step random access procedure can be performed as follows. FIG. 13 illustrates a sequence diagram for timing enhancement on 4-step RACH for a regenerative satellite (e.g., with gNB/satellite processed payload), in accordance with some embodiments of the present disclosure. FIG. 14 illustrates a sequence diagram for timing enhancement on failure of 4-step RACH for a regenerative satellite (e.g., with gNB/satellite processed payload), in accordance with some embodiments of the present disclosure.

Before a random access procedure begins, a satellite may send a synchronization signal block (SSB), system information (SI), a waiting duration T_{wait} and/or a serving duration Tₛₑᵣᵥₑ to a UE. The waiting duration can be indicated with following options.

Option-1: As a constant value of waiting duration T_{wait}, T_{wait}>T_{period}, which ensures the successful communication and/or processing of Msg1 with a network configuration at a minimum RSRP threshold, an elevation angle threshold or a distance threshold.

Option-2: As an offset and a constant value of waiting duration, Twait=ΔT+T_{wait,initial}, where values of the offset can be mapped with respective values of RSRP threshold, elevation angle threshold, and/or distance threshold. For example, the following Table 3 may be configured.

TABLE 3

| The offset of waiting | RSRP | Elevation angle | Distance |
|---|---|---|---|
| duration | threshold | threshold | threshold |
| ΔT₁ | X1 | Y1 | Z1 |
| ΔT₂ | X2 | Y2 | Z2 |
| ΔTₙ, ΔTₘ, ΔTⱼ | Xn | Ym | Zj |

At t1 time, a UE may send Msg1 to a satellite and may wait for Msg2 at/within a RAR window with a delay of 2*TA (e.g., TA can be the calculated propagation delay between the UE and the satellite).

At t2 time, the UE may receive Msg2 if Msg1 is decoded correctly by an on-board base station. Otherwise, the UE may restart the random access procedure with a higher UL coverage by using a time offset (e.g., higher RSRP; ΔT≤Tₛₑᵣᵥₑ), a higher elevation angle, or a lower distance according to the mapping table above.

At t3 time, the UE may send Msg3 to the satellite and may wait for Msg4 within a contention resolution timer after (e.g., adjusted/delayed/shifted by) a delay of 2*TA. TA can be a calculated propagation delay between the UE and the satellite at t3 time.

At t4 time, if Msg4 is decoded successfully, the random access can be complete. Otherwise, the UE may restart the random access with a higher UL coverage by using a larger offset ΔT within the serving duration of Tₛₑᵣᵥₑ. If ΔT>Tₛₑᵣᵥₑ, the UE may restart and may delay the random access with a configured waiting duration of T_{wait}.

When timer of Tₛₑᵣᵥₑ is expired, the UE may interrupt its transmission.

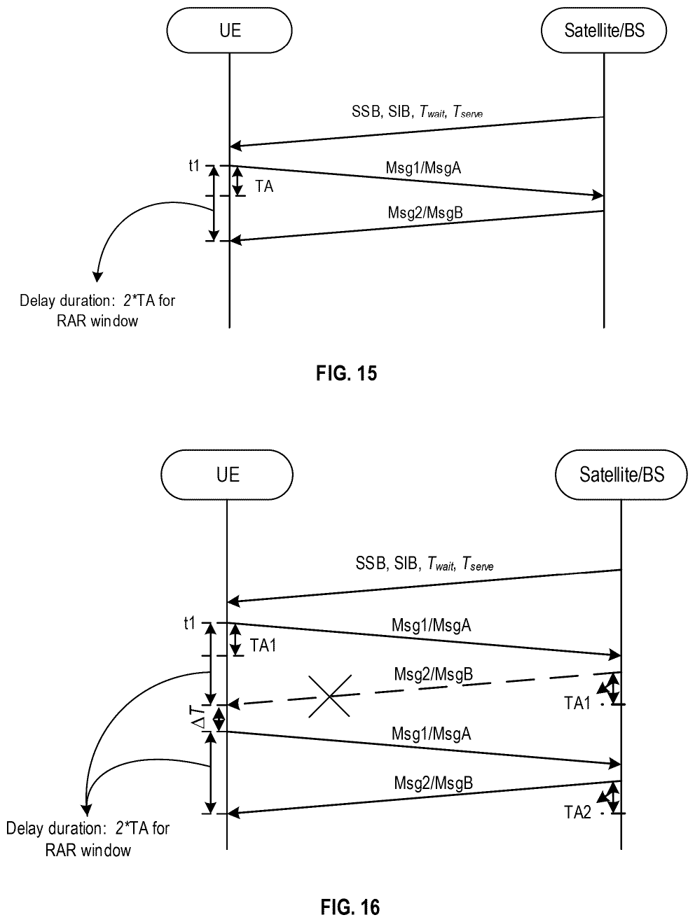

Case 2-2: For regenerative satellite, gNB processed payload, a timing enhancement on 2-step random access procedure or contention-free random access procedure, an application of a waiting duration T_{wait} and a serving duration Tₛₑᵣᵥₑ can be also feasible. FIG. 15 illustrates a sequence diagram for timing enhancement on 2-step RACH/CF RACH for regenerative satellite (e.g., gNB/satellite processed payload), in accordance with some embodiments of the present disclosure. FIG. 16 illustrates a sequence diagram for timing enhancement on failure of 2-step RACH/CF RACH for a regenerative satellite, gNB processed payload, in accordance with some embodiments of the present disclosure.

Before a random access procedure starts/occurs, a satellite may send a synchronization signal block (SSB), system information (SI), a waiting duration T_{wait} and/or a serving duration Tₛₑᵣᵥₑ to a UE. The waiting duration can be indicated with following options.

Option-1: As a constant value of waiting duration T_{wait} larger than a period duration of satellite orbit, T_{wait}>T_{period}, which can ensure the success of Msg1/MsgA with a network configuration at a minimum RSRP threshold, an elevation angle threshold, or a distance threshold.

Option-2: As an offset and a constant value of waiting duration, Twait=ΔT+T_{wait,initial}, where each value of the offset can be mapped with a respective value of the RSRP threshold, the elevation angle threshold, and/or the distance threshold. The time offset can be less than the serving duration (e.g., ΔT≤Tₛₑᵣᵥₑ). For example. the following Table 4 may be configured.

TABLE 4

| The offset of | RSRP | Elevation angle | Distance |
|---|---|---|---|
| waiting duration | threshold | threshold | threshold |
| ΔT₁ | X1 | Y1 | Z1 |
| ΔT₂ | X2 | Y2 | Z2 |
| ΔTₙ, ΔTₘ, ΔTⱼ | Xn | Ym | Zj |

At t1 time, a UE may send Msg1/MsgA to a satellite and may wait for Msg2/MsgB at/within a RAR window with a delay of 2*TA. The TA can be the propagation delay between the UE and the satellite.

At t2 time, the UE may receive Msg2/MsgB if Msg1/MsgA is decoded correctly by an on-board base station. Otherwise, the UE may restart the random access with a higher UL coverage by using a time offset (e.g., higher RSRP), a higher elevation angle, or a lower distance according to the mapping table above (where ΔT≤Tₛₑᵣᵥₑ). If ΔT>Tₛₑᵣᵥₑ, the UE may restart and may delay the random access with the configured waiting duration of T_{wait}.

### Implementation Example 3: Timing Enhancement of RACH is Based on Waiting Duration and Serving Duration for Regenerative Satellite With an on-Board gNB-DU

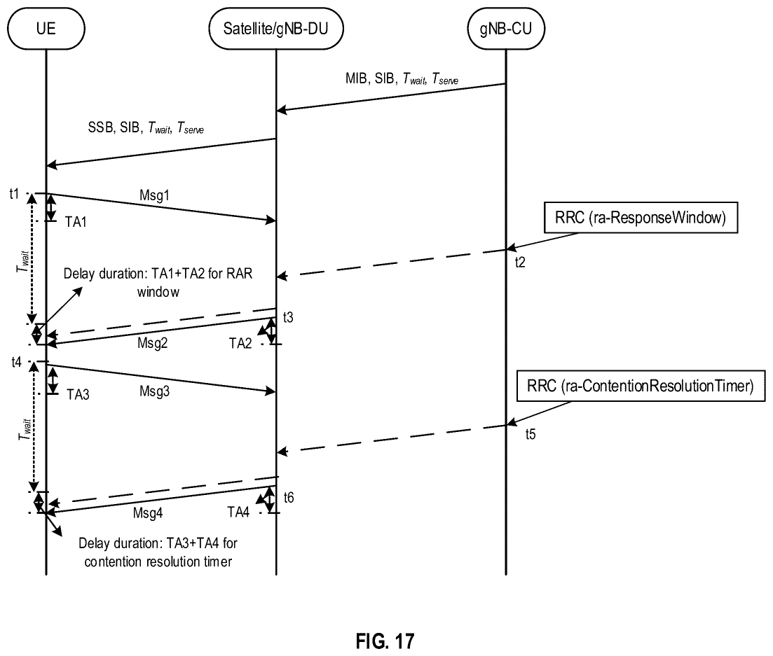

Case 3-1: For a regenerative satellite, gNB-DU processed payload, a timing enhancement on 4-step random access can be specified. FIG. 17 illustrates a sequence diagram for timing enhancement on 4-step RACH for a regenerative satellite, with a gNB DU/CU split, in accordance with some embodiments of the present disclosure. For a CU/DU split, a UE may wait for a waiting duration of T_{wait} to receive a radio resource control (RRC) signaling from a gNB centralized unit (gNB-CU). The following procedures can be modified.

Before a random access procedure, a satellite may send a stored synchronization signal block (SSB), system information (SI), a waiting duration T_{wait} and/or a serving duration Tₛₑᵣᵥₑ to a UE. The waiting duration can be indicated with following options.

Option-1: A constant value of waiting duration T_{wait}, T_{wait}>T_{period}, which can ensure the successful communication and/or processing of Msg1 with a network configuration (e.g., a PRACH occasion, a preamble index) at a minimum RSRP threshold, an elevation angle threshold, or a distance threshold. The waiting duration may include at least one of: a period duration of a satellite orbit, a processing duration at a gateway, or a round propagation delay between the satellite and the gateway, or a round propagation delay between the satellite and the UE.

Option-2: As an offset and a constant value of waiting duration, Twait=ΔT+T_{wait,initial}, where the offset can be mapped with the RSRP threshold, an elevation angle threshold, and a distance threshold. For example, the following Table 5 may be configured.

TABLE 5

| The offset of | RSRP | Elevation angle | Distance |
|---|---|---|---|
| waiting duration | threshold | threshold | threshold |
| ΔT₁ | X1 | Y1 | Z1 |
| ΔT₂ | X2 | Y2 | Z2 |
| ΔTₙ, ΔTₘ, ΔTⱼ | Xn | Ym | Zj |

At t1 time, a UE may send Msg1 to a satellite and may start a timer of a timing duration T wait to wait for Msg2. The UE may calculate and may store the TA1 (e.g., a propagation delay between the UE and the satellite).

At t2 time, a gNB centralized unit (gNB-CU) may send radio resource control (RRC) information (e.g., ra-Response Window) to a satellite gNG distributed unit (gNB-DU) if Msg1 is decoded correctly.

At t3 time, the satellite may forward the stored RRC information of ra-Response Window and Msg2 to the UE when the timer of waiting duration T_{wait} is expired. The UE may receive Msg2 at the RAR window with a delay of the sum of TA1+TA2. TA1 can be a calculated propagation delay stored by the UE at t1 time. TA2 can be a calculated propagation delay between the UE and the satellite at t3 time. Otherwise, if Msg2 is not received by the UE, the UE may restart the random access with a higher UL coverage. For example, the random access may be restarted with a delay of larger time offset at a higher RSRP, a higher elevation angle, or a lower distance according to the mapping table above.

At t4 time, the UE may send Msg3 with a timing advance of the sum of TA1+TA2. TA2 can be the propagation delay between the UE and the satellite. The UE may wait for Msg4 within a contention resolution timer after a delay of TA3+TA4 when the timer of waiting duration T_{wait} is expired. TA3 and TA4 can be the calculated propagation delay between the UE and the satellite when the UE sends Msg3 and receive Msg4, respectively.

At t5 time, the gNB-CU may send RRC information of ra-ContentionResolutionTimer to the satellite gNB-DU when Msg3 is correctly decoded.

At t6 time, the satellite may forward the stored RRC information of ra-ContentionResolutionTimer and Msg4 to the UE when satellite passes through the UE. If Msg4 is decoded successfully, the random access can be complete. Otherwise, the UE may restart the random access with a higher UL coverage by new offset of ΔTwithin the serving duration of Tₛₑᵣᵥₑ.

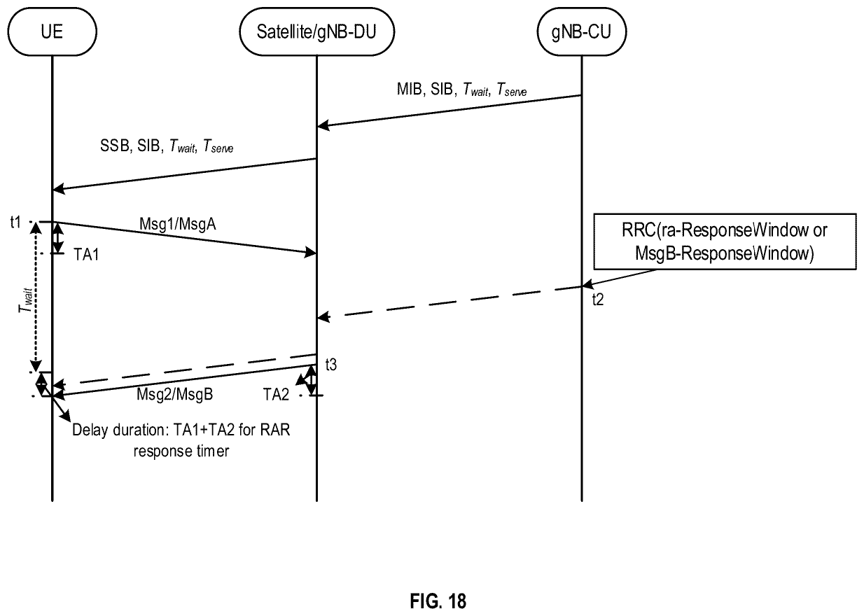

Case 3-2: For regenerative satellite (e.g., gNB-DU/satellite processed payload, a timing enhancement on 2-step random access or contention-free random access can be specified. The application of a waiting duration T_{wait} and a serving duration Tₛₑᵣᵥₑ can be feasible. FIG. 18 illustrates a sequence diagram for timing enhancement on 2-step RACH/CF RACH for regenerative satellite, gNB DU/CU split, in accordance with some embodiments of the present disclosure.

Before a random access procedure, a satellite may send a stored SSB, SI, a waiting duration T_{wait}, and/or a serving duration Tₛₑᵣᵥₑ to a UE. The waiting duration can be indicated with following options.

Option-1: As a constant value of waiting duration T_{wait} lager than a period duration of satellite orbit, T_{wait}≥T_{period}, which at least ensure success communication and/or processing of Msg1/MsgA with a network configuration at a minimum higher reference signal received power (RSRP) threshold, an elevation angle threshold, or a distance threshold.

Option-2: As an offset and a constant value of waiting duration, Twait=ΔT+T_{wait,initial}, where a value of the offset can be mapped with corresponding value of the RSRP threshold, the elevation angle threshold, and/or the distance threshold. Time offset can be less than serving duration (e.g., ΔT≤Tₛₑᵣᵥₑ). For example, the following Table 6 may be configured.

TABLE 6

| The offset of waiting | RSRP | Elevation angle | Distance |
|---|---|---|---|
| duration | threshold | threshold | threshold |
| ΔT₁ | X1 | Y1 | Z1 |
| ΔT₂ | X2 | Y2 | Z2 |
| ΔTₙ, ΔTₘ, ΔTⱼ | Xn | Ym | Zj |

At t1 time, a UE may send Msg1/MsgA to a satellite gNB-DU. The UE may start a timer of timing duration T_{wait} to wait for Msg2/MsgB. The UE may calculate and may store a TA1 (e.g., a propagation delay between the UE and the satellite).

At t2 time, a gNB-CU may send RRC information of RAR-ResponseWindow or MsgB-Response Window to a satellite gNB-DU when satellite passes through the gNB-CU.

At t3 time, the satellite gNB-DU may send RRC information of RAR-Response Window/MsgB-Response Window and Msg2/MsgB to UE if Msg1/MsgA is decoded correctly.

At t4 time, when the timer of waiting duration T_{wait} has expired, the UE may receive Msg2/MsgB at the RAR window with/after a delay of the sum of TA1+TA2. TA2 can be a calculated propagation delay between the UE and the satellite at t4 time. Otherwise, if Msg2/MsgB is not received by the UE, the UE may restart the random access with a higher UL coverage. For example, the random access can be restarted with a delay of larger time offset at a higher RSRP, a higher elevation angle, or a lower distance according to the mapping table above.

For the successful decoding of preamble but failure of Msg3 for MsgA, the waiting duration can be used for fallback procedures of 4-step RACH.

### Implementation Example 4: Timing Enhancement of RACH is Based on a Waiting Duration and a Common TA

When a UE has no global navigation satellite system (GNSS) module, a propagation delay (e.g., TA1, TA2) between the UE and a satellite may not be calculated by the UE, then a collision can occur at a random access response (RAR) window. To cover a round-trip time (RTT) between the UE and the satellite, an extension of RAR window can be helpful to eliminate the impact of maximum RTT differential delay. The extension range of RAR window can depend on the common TA with following methods.

(1) When a common TA is configured by a network, a timing relationship can be achieved by an application of T_{wait} and common TA (for all UEs). The extension of RAR window can be used to cover maximum RTT differential delay (for all UEs).

(2) Without a common TA (configured by network), an application of T_{wait} can be used to extend/update a RAR window, a contention resolution timer, and a large range for extension of RAR window to cover maximum RTT.

It should be understood that one or more features from the above implementation examples are not exclusive to the specific implementation examples, but can be combined in any manner (e.g., in any priority and/or order, concurrently or otherwise).

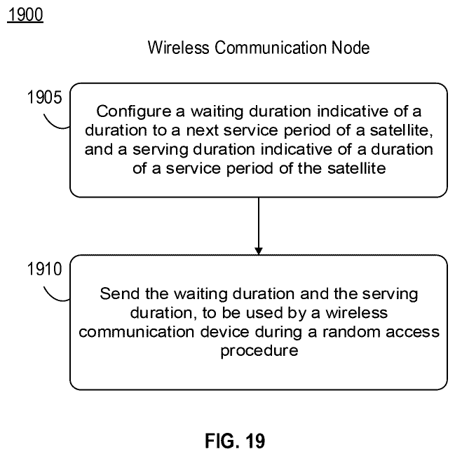

FIG. 19 illustrates a flow diagram of a method 1900 for timing enhancement in store and forward mode. The method 1900 may be implemented using any one or more of the components and devices detailed herein in conjunction with FIGS. 1-2. In overview, the method 1900 may be performed by a communication wireless node, in some embodiments. Additional, fewer, or different operations may be performed in the method 1900 depending on the embodiment. At least one aspect of the operations is directed to a system, method, apparatus, or a computer-readable medium.

A wireless communication node (e.g., a base station (BS), which can be part of a regenerative satellite, or separate from a satellite for instance) may configure a waiting duration indicative of a duration (e.g., T_{wait}) to a next service period of a satellite, and a serving duration indicative of a duration (e.g., Tₛₑᵣᵥₑ) of a service period of the satellite. The wireless communication node may send the (indication of the) waiting duration and the serving duration, to be used by a wireless communication device (e.g., a user equipment (UE)) during a random access procedure. In some embodiments, the wireless communication node (e.g., a regenerative satellite) may send the waiting duration and the serving duration to a UE directly. In certain embodiments, the wireless communication node (e.g., a BS) may send the waiting duration and the serving duration to a UE via a satellite (e.g., a transparent satellite). The random access procedure may comprise a 4-step random access procedure, or a 2-step or contention-free random access procedure.

In some embodiments, the waiting duration may include at least one of: a duration of one orbital cycle of the satellite, a processing duration at the wireless communication node, a round trip propagation time between the satellite and the wireless communication node, a round trip propagation time between the satellite and the wireless communication device, a fixed value, or a sum of a fixed value and an offset value.

In some embodiments, the wireless communication node may send the waiting duration and the serving duration to the satellite via at least one of: a master information block (MIB) signaling, a system information block (SIB) signaling, or a radio resource control (RRC) signaling. The satellite may store the waiting duration and the serving duration. The satellite may send the waiting duration and the serving duration to the wireless communication device.

In some embodiments, the wireless communication device may send, during a first instance of the serving duration, a Msg1 or MsgA to the satellite at a start time of a first instance of the waiting period (e.g., t1 in FIG. 9). The satellite may send a Msg2 or MsgB to the wireless communication device responsive to expiration of the first instance of the waiting period (e.g., t4 in FIG. 9). The wireless communication device may receive the Msg2 or MsgB from the satellite in a random access response (RAR) window with a delay comprising a sum of a first timing advance (TA1) and a second timing advance (TA2). The wireless communication device may send, during a second instance of the serving duration, a Msg3 with a timing advance comprising the sum of the TA1 and the TA2, at a start time of a second instance of the waiting period (e.g., t5 in FIG. 9). The wireless communication device may monitor to receive a Msg4 in a contention resolution window after a delay comprising a sum of a third timing advance (TA3) and a fourth timing advance (TA4), after expiration of the second instance of the waiting period.

In some embodiments, the wireless communication device may determine to send the Msg1, the Msg3 or the MsgA if (e.g., on condition that) at least one of: a calculated elevation angle is greater than a threshold of elevation angle, a measured reference signal received power (RSRP) is higher than a RSRP threshold, a calculated distance is less than a distance threshold between the wireless communication device and the satellite, or a residual portion of the serving duration calculated by wireless communication device is larger than a sum of a scheduled duration (e.g., K, the scheduled duration for DCI scheduled Msg3) and a round trip propagation time between the satellite and the wireless communication device.

In some embodiments, the TA1 can be a propagation delay calculated by the wireless communication device at the start time of the first instance of the waiting period (e.g., t1 in FIG. 9). The TA2 can be a propagation delay between the wireless communication device and the satellite calculated when the satellite sends the Msg2 or MsgB (e.g., t4 in FIG. 9) to the wireless communication device. The TA3 can be a propagation delay between the wireless communication device and the satellite calculated when the wireless communication device sends the Msg3 (e.g., t5 in FIG. 9). The TA4 can be a propagation delay between the wireless communication device and the satellite calculated when the wireless communication device receives the Msg4 (e.g., t8 in FIG. 9).

In some embodiments, if the Msg2, Msg4 or MsgB is not (e.g., not successfully) received by the wireless communication device responsive to expiration of the first instance or second instance of the waiting period: the wireless communication device may re-send the Msg1, Msg3 or MsgA to the satellite at a start time of another instance of the waiting period, after a defined offset time (ΔT, mapped to higher uplink (UL) coverage for instance).

In some embodiments, the wireless communication node on the satellite may send the waiting duration and the serving duration to the wireless communication device. The wireless communication device may send, during a first instance of the serving duration, a Msg1 or MsgA to the satellite at a start time of a first instance of the waiting period (e.g., t1 in FIG. 13). The satellite may send a Msg2 or MsgB to the wireless communication device (e.g., t2 in FIG. 13). Responsive to expiration of the first instance of the waiting period, the wireless communication device may receive a Msg2 from the satellite in a random access response (RAR) window with a delay comprising two times of a timing advance (TA). The wireless communication device may send, during a second instance of the serving duration, a Msg3 at a start time of a second instance of the waiting period (e.g., t3 in FIG. 13). The wireless communication device may monitor to receive a Msg4 in a contention resolution window after a delay comprising two times of the TA, after expiration of the second instance of the waiting period. The TA can be a propagation delay between the wireless communication device and the satellite. If the Msg2, Msg4 or MsgB is not received by the wireless communication device responsive to expiration of the first instance or second instance of the waiting period: the wireless communication device can re-send the Msg1, Msg3 or MsgA to the satellite at a start time of another instance of the waiting period, after a defined offset time (ΔT, mapped to higher uplink (UL) coverage for example).

In some embodiments, the wireless communication node (e.g., gNB-CU) may send (an indication of) the waiting duration and the serving duration to the satellite. The satellite may store the waiting duration and the serving duration. The satellite may send the waiting duration and the serving duration to the wireless communication device. The wireless communication device may send, during a first instance of the serving duration, a Msg1 or MsgA to the satellite at a start time of a first instance of the waiting period (e.g., t1 in FIG. 17). The satellite may send a Msg2 or MsgB to the wireless communication device responsive to expiration of the first instance of the waiting period (e.g., t3 in FIG. 17). The wireless communication device may receive the Msg2 or

MsgB and first radio resource control (RRC) information from the satellite, in/during a random access response (RAR) window with/after a delay comprising a sum of a first timing advance (TA1) and a second timing advance (TA2). The wireless communication device may send, during a second instance of the serving duration, a Msg3 with/after a timing advance comprising the sum of the TA1 and the TA2, at a start time of a second instance of the waiting period (e.g., t4 in FIG. 17). The wireless communication device may monitor to receive a Msg4 and second RRC information, in/during a contention resolution window after a delay comprising a sum of a third timing advance (TA3) and a fourth timing advance (TA4), after expiration of the second instance of the waiting period.

In some embodiments, the TA1 can be a propagation delay calculated by the wireless communication device at the start time of the first instance of the waiting period (e.g., t1 in FIG. 17). The TA2 can be a propagation delay between the wireless communication device and the satellite, that is calculated/determined (e.g., using a GNSS module of the wireless communication device) when the satellite sends the Msg2 or MsgB to the wireless communication device (e.g., t3 in FIG. 17). The TA3 can be a propagation delay between the wireless communication device and the satellite calculated/determined (e.g., using a GNSS module of the wireless communication device) when the wireless communication device sends the Msg3 (e.g., t4 in FIG. 17). The TA4 can be a propagation delay between the wireless communication device and the satellite calculated when the wireless communication device receives the Msg4. If the Msg2, Msg4 or MsgB is not received by the wireless communication device responsive to expiration of the first instance or second instance of the waiting period: the wireless communication device may re-send the Msg1, Msg3 or MsgA (e.g., attempt to send another Msg1 or MsgA) to the satellite at a start time of another instance of the waiting period, after a defined offset time (ΔT, mapped to higher uplink (UL) coverage). The wireless communication device may receive the Msg2 or MsgB from the satellite in a RAR window that is extended to incorporate a common timing advance (e.g., configured/determined by the wireless communication node) for a plurality of wireless communication devices, or a maximum round-trip propagation delay between the wireless communication device and the satellite. The wireless communication device may monitor to receive the Msg4 in a contention resolution window that is extended/modified to incorporate the common timing advance, or the maximum round-trip propagation delay between the wireless communication device and the satellite.

In some embodiments, a wireless communication device (e.g., a UE) may receive a configuration comprising a waiting duration indicative (e.g., T_{wait}) of a duration to a next service period of a satellite, and a serving duration indicative (e.g., Tₛₑᵣᵥₑ) of a duration of a service period of the satellite, to be used during a random access procedure. The waiting duration and the serving duration can be configured by a wireless communication node (e.g., a BS, which can be part of a regenerative satellite for instance).

While various embodiments of the present solution have been described above, it should be understood that they have been presented by way of example only, and not by way of limitation.

Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A method comprising:
receiving, by a wireless communication device, a configuration comprising a waiting duration indicative of a duration to a next service period of a satellite, and a serving duration indicative of a duration of a service period of the satellite, to be used during a random access procedure,
wherein the waiting duration and the serving duration are configured by a wireless communication node.

2. The method of claim 1, wherein the random access procedure comprises a 4-step random access procedure, or a 2-step or contention-free random access procedure.

3. The method of claim 1, wherein the waiting duration includes at least one of:
a duration of one orbital cycle of the satellite,
a processing duration at the wireless communication node,
a round trip propagation time between the satellite and the wireless communication node,
a round trip propagation time between the satellite and the wireless communication device,
a fixed value, or
a sum of a fixed value and an offset value.

4. The method of claim 1, wherein:
the wireless communication node sends the waiting duration and the serving duration to the satellite via at least one of: a master information block (MIB) signaling, a system information block (SIB) signaling, or a radio resource control (RRC) signaling, and
the satellite stores the waiting duration and the serving duration, and sends the waiting duration and the serving duration to the wireless communication device.

5. The method of claim 4, comprising at least one of:
sending, by the wireless communication device, during a first instance of the serving duration, a Msg1 or MsgA to the satellite at a start time of a first instance of the waiting period,
receiving, by the wireless communication device from the satellite, a Msg2 or MsgB to responsive to expiration of the first instance of the waiting period,
receiving, by the wireless communication device, the Msg2 or MsgB from the satellite in a random access response (RAR) window with a delay comprising a sum of a first timing advance (TA1) and a second timing advance (TA2),
sending by the wireless communication device, during a second instance of the serving duration, a Msg3 with a timing advance comprising the sum of the TA1 and the TA2, at a start time of a second instance of the waiting period, or
monitoring, by the wireless communication device, to receive a Msg4 in a contention resolution window after a delay comprising a sum of a third timing advance (TA3) and a fourth timing advance (TA4), after expiration of the second instance of the waiting period.

6. The method of claim 5, wherein
the wireless communication device determines to send the Msg1, the Msg3 or the MsgA if at least one of:
a calculated elevation angle is greater than a threshold of elevation angle,
a measured reference signal received power (RSRP) is higher than a RSRP threshold,
a calculated distance is less than a distance threshold between the wireless communication device and the satellite, or
a residual portion of the serving duration calculated by wireless communication device is larger than a sum of a scheduled duration and a round trip propagation time between the satellite and the wireless communication device.

7. The method of claim 5, wherein at least one of:
the TA1 is a propagation delay calculated by the wireless communication device at the start time of the first instance of the waiting period,
the TA2 is a propagation delay between the wireless communication device and the satellite calculated when the satellite sends the Msg2 or MsgB to the wireless communication device,
the TA3 is a propagation delay between the wireless communication device and the satellite calculated when the wireless communication device sends the Msg3, or
the TA4 is a propagation delay between the wireless communication device and the satellite calculated when the wireless communication device receives the Msg4.

8. The method of claim 5, wherein if the Msg2, Msg4 or MsgB is not received by the wireless communication device responsive to expiration of the waiting period, the method comprises:
re-sending, by the wireless communication device, the Msg1, Msg3 or MsgA to the satellite at a start time of another instance of the waiting period, after a defined offset time.

9. The method of claim 1, comprising:
receiving, by the wireless communication device from the wireless communication node on the satellite, the waiting duration and the serving duration.

10. The method of claim 9, comprising at least one of:
sending, by the wireless communication device, during a first instance of the serving duration, a Msg1 or MsgA to the satellite at a start time of a first instance of the waiting period,
receiving, by the wireless communication device from the satellite, a Msg2 or MsgB,
responsive to expiration of the first instance of the waiting period, receiving, by the wireless communication device, a Msg2 from the satellite in a random access response (RAR) window with a delay comprising two times of a timing advance (TA),
sending, by the wireless communication device, during a second instance of the serving duration, a Msg3 at a start time of a second instance of the waiting period, or
monitoring, by the wireless communication device, to receive a Msg4 in a contention resolution window after a delay comprising two times of the TA, after expiration of the second instance of the waiting period.

11. The method of claim 10, wherein the TA is a propagation delay between the wireless communication device and the satellite.

12. The method of claim 10, wherein if the Msg2, Msg4 or MsgB is not received by the wireless communication device responsive to expiration of the waiting period, the method comprises:
re-sending, by the wireless communication device, the Msg1, Msg3 or MsgA to the satellite at a start time of another instance of the waiting period, after a defined offset time.

13. The method of claim 1,
wherein the wireless communication node sends the waiting duration and the serving duration to the satellite, and
wherein the satellite stores the waiting duration and the serving duration, and sends the waiting duration and the serving duration to the wireless communication device.

14. The method of claim 13, comprising at least one of:
sending, by the wireless communication device, during a first instance of the serving duration, a Msg1 or MsgA to the satellite at a start time of a first instance of the waiting period,
receiving, by the wireless communication device from the satellite, a Msg2 or MsgB responsive to expiration of the first instance of the waiting period,
receiving, by the wireless communication device, the Msg2 or MsgB and first radio resource control (RRC) information from the satellite in a random access response (RAR) window with a delay comprising a sum of a first timing advance (TA1) and a second timing advance (TA2),
sending, by the wireless communication device, during a second instance of the serving duration, a Msg3 with a timing advance comprising the sum of the TA1 and the TA2, at a start time of a second instance of the waiting period, or
monitoring, by the wireless communication device, to receive a Msg4 and second RRC information in a contention resolution window after a delay comprising a sum of a third timing advance (TA3) and a fourth timing advance (TA4), after expiration of the second instance of the waiting period.

15. The method of claim 14, wherein at least one of:
the TA1 is a propagation delay calculated by the wireless communication device at the start time of the first instance of the waiting period,
the TA2 is a propagation delay between the wireless communication device and the satellite calculated when the satellite sends the Msg2 or MsgB to the wireless communication device,
the TA3 is a propagation delay between the wireless communication device and the satellite calculated when the wireless communication device sends the Msg3, or
the TA4 is a propagation delay between the wireless communication device and the satellite calculated when the wireless communication device receives the Msg4.

16. The method of claim 15, wherein if the Msg2, Msg4 or MsgB is not received by the wireless communication device responsive to expiration of the waiting period, the method comprises:
re-sending, by the wireless communication device, the Msg1, Msg3 or MsgA to the satellite at a start time of another instance of the waiting period, after a defined offset time.

17. The method of claim 5, comprising at least one of:
receiving, by the wireless communication device, the Msg2 or MsgB from the satellite in a RAR window that is extended to incorporate a common timing advance for a plurality of wireless communication devices, or a maximum round-trip propagation delay between the wireless communication device and the satellite, or
monitoring, by the wireless communication device, to receive the Msg4 in a contention resolution window that is extended to incorporate the common timing advance, or the maximum round-trip propagation delay between the wireless communication device and the satellite.

18. A wireless communication device, comprising:
at least one processor configured to:
receive, via a receiver, a configuration comprising a waiting duration indicative of a duration to a next service period of a satellite, and a serving duration indicative of a duration of a service period of the satellite, to be used during a random access procedure,
wherein the waiting duration and the serving duration are configured by a wireless communication node.

19. A method comprising:
configuring, by a wireless communication node, a waiting duration indicative of a duration to a next service period of a satellite, and a serving duration indicative of a duration of a service period of the satellite; and
sending, by the wireless communication node, the waiting duration and the serving duration, to be used by a wireless communication device during a random access procedure.

20. A wireless communication node, comprising:
at least one processor configured to:
configure a waiting duration indicative of a duration to a next service period of a satellite, and a serving duration indicative of a duration of a service period of the satellite; and
send, via a transmitter, the waiting duration and the serving duration, to be used by a wireless communication device during a random access procedure.
